(19) United States
(12) Patent Application Publication
(10) Pub. No.: US 2024/0087389 A1
(43) Pub. Date: Mar. 14, 2024

(54) METHOD OF MANAGING PARKING ACCESS INTO OR EXITING FROM A MULTI-RESIDENTIAL BUILDING

(71) Applicant: Jean-Pierre POULIN, Chelsea (CA)

(72) Inventor: Jean-Pierre POULIN, Chelsea (CA)

(73) Assignee: 1VALET CORP., Gatineau, QC (CA)

(21) Appl. No.: 18/101,678

(22) Filed: Jan. 26, 2023

Related U.S. Application Data
(63) Continuation-in-part of application No. PCT/CA2022/051356, filed on Sep. 9, 2022.

(51) Int. Cl. G07C 9/27

(52) U.S. Cl. CPC G07C 9/27; G07C 2209/02

(57) ABSTRACT

In accordance with an embodiment of the present disclosure, there is provided a method of managing parking access into or exiting from a multi-residential building. The method includes: receiving a request of entry or exit in a building operation system (BOS) from an object via an interface; upon receiving the request of entry or exit, sending a validation request relating to a plurality of security parameters, from the BOS to the object, the plurality of security parameters being either randomly selected in real time or pre-selected by a user, from a list of security parameters pre-determined and stored in a server, receiving a response in the BOS, generated in real time to the validation request by the object; and upon determination of a valid response to the validation request by the BOS, sending a response to the request of entry or exit to the object, wherein the response is a denial or an approval.

### CROSS-REFERENCE TO RELATED APPLICATIONS

The present application is a Continuation-in-Part of International Application No. PCT/CA2022/051356, designating the United States, filed Sep. 9, 2022, which claims priority to U.S. Provisional Patent Application No. 63/242,129, filed Sep. 9, 2021. The foregoing applications are incorporated by reference herein in their entirety.

### FIELD OF THE INVENTION

The present disclosure generally relates to methods and systems for managing parking services, and in particular to methods and systems for managing parking access into or exiting from a multi-residential building.

### BACKGROUND

Nowadays a multi-residential building typically includes various common facilities such as parking and concierge services. A tenant of the building may use a key card or a transponder to enter or exit the building (e.g., via a parking garage). However, if a third party obtains the key card or the transponder by unauthorized means (such as theft), the security of the building would be greatly compromised.

Furthermore, when a guest of a tenant needs to enter or exit the building, the presence of the tenant or assistance of a staff person from the building management team may be required, thus resulting in inconvenience or inefficiency of managing building services such as parking management. Sometimes, a guest may be allowed to enter the building by merely leaving a name or contact number of a tenant at the reception of the building without any further identity checks or validations for security purposes, which may also result in compromising the security of the building.

Therefore, there is a need for methods and systems that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide methods, systems and computer readable medium for managing parking access into or exiting from a multi-residential building, using a building operating system (BOS). In accordance with embodiments of the present disclosure, a building operating system (BOS) may be integrated with entities and devices to facilitate the embodiments described herein.

In accordance with an aspect of the present disclosure, there is provided a method of managing parking access into or exiting from a multi-residential building. The method includes: receiving a request of entry or exit in a building operation system (BOS) from an object via an interface; upon receiving the request of entry or exit, sending a validation request relating to a plurality of security parameters, from the BOS to the object, the plurality of security parameters being selected from a list of security parameters pre-determined and stored in a server, the number of the plurality of security parameters selected being less than or equal to the number of security parameters in the list of security parameters; receiving a response to the validation request in the BOS, the response being generated by the object in real time; and upon determination of a valid response to the validation request by the BOS, sending a response to the request of entry or exit to the object, wherein the response is a denial or an approval.

In accordance with the embodiments, the plurality of security parameters is randomly selected from the list of security parameters in real time by the BOS.

In accordance with the embodiments, the plurality of security parameters is pre-selected by a user associated with the object from the list of security parameters.

In accordance with the embodiments, when the response from the BOS is an approval, the method further includes an access control system performing one or more post-validation actions. In embodiments, the one or more post-validation actions include: automatically opening or closing a garage or a gate, turning on or off an oven, a light, heating, or music, automating an elevator going up or down to a designated place, assigning a parking space, or processing a payment or a fee.

In accordance with the embodiments, when the response from the BOS is a denial, the method further includes an access control system performing one or more notification actions. In embodiments, the one or more notification actions include: sending an additional validation request relating to another selected plurality of security parameters, by the BOS to the object; or allowing an authorization user to override the response to the request of entry or exit.

In embodiments, the request of entry or exit includes an automatically generated request upon the object approaching the multi-residential building.

In embodiments, the request of entry or exit includes a request being manually launched by the object.

In embodiments, the request of entry or exit includes an automatically generated request upon movement of the object.

In embodiments, when the object is a vehicle and the security parameters include one or more identifiers of the vehicle, selected from: a code associated with the vehicle; a license of the vehicle; a colour of the vehicle; a make of the vehicle; a model of the vehicle; a driving pattern of the vehicle; an IP address of the vehicle; a GPS location of the vehicle; and an electronic device carried with the vehicle.

In embodiments, when the object is a person and the security parameters include one or more identifiers of the person, selected from: a code associated with the person; a facial recognition of the person; a voice recognition of the person; one or more security questions to be answered by the person; a biometric record of the person including digital fingerprint(s); a digital form of behavioral biometrics of the person; and an electronic device carried with the person.

In accordance with the embodiments, the method further includes registering the object in the multi-residential building. In particular, the method further includes: receiving, by the BOS from a source, a request to register the object, the request including adding information of the object; upon determination of a valid request by the BOS, sending, by the BOS towards the server, the request to register the object; completing the request to register the object including adding the information of the object in the server; receiving, by the BOS from the server, an acknowledgement that the object has been registered; and sending, by the BOS toward the source, an acknowledgement that the object has been registered. In embodiments, the information includes one or more security parameters.

In accordance with the embodiments, the method further includes unregistering the object which is previously registered in the multi-residential building. In particular, the method further includes: receiving, by the BOS from a source, a request to unregister the object, the request comprising removing information of the object; upon determination of a valid request by the BOS, sending, by the BOS towards the server, the request to unregister the object; completing the request to unregister the object including removing the information of the object in the server; receiving, by the BOS from the server, an acknowledgement that the object has been unregistered; and sending, by the BOS toward the source, an acknowledgement that the object has been unregistered. In embodiments, the information includes one or more security parameters.

In accordance with the embodiments, the method further includes updating the object which is previously registered in the multi-residential building. In particular, the method further includes: receiving, by the BOS from a source, a request to update the object, the request comprising updating information of the object; upon determination of a valid request by the BOS, sending, by the BOS towards the server, the request to update the object; completing the request to update the object including update the information of the object in the server; receiving, by the BOS from the server, an acknowledgement that the object has been updated; and sending, by the BOS toward the source, an acknowledgement that the object has been updated. In embodiments, the information includes one or more security parameters.

In accordance with the embodiments, the interface includes one or more of: a device configured to recognize an identifier of the object; a mobile application; a transponder; and a wireless router.

In embodiments, the source includes a mobile application, a user device and a BOS portal.

In embodiments, the BOS includes a server and an access control system.

In embodiments, the code includes one of: a one-dimensional linear bar code; a two-dimensional bar code, an image, a specialized augmented postal code; an intelligent mail barcode; and an electronic product code.

In accordance with another aspect of the present disclosure, there is provided a tangible, non-transitory computer readable medium having instructions recorded thereon to be performed by at least one processor to carry out a method as defined in any one of aforementioned methods.

In accordance with another aspect of the present disclosure, there is provided a configured to carry out a method as defined in any one of aforementioned methods. The system includes at least one processor and a tangible, non-transitory computer readable medium. The computer readable medium includes instructions recorded thereon to be performed by the at least one processor of the system to carry out a method as defined in any one of aforementioned methods.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates an example method of registering or unregistering an object (e.g., a vehicle) with a building operating system, according to an embodiment of the present disclosure.

FIG. 2 illustrates an example method for managing parking access or exiting from a multi-residential building, according to an embodiment of the present disclosure.

FIG. 3 illustrates, in a schematic diagram, an electronic device in accordance with embodiments of the present disclosure.

FIG. 4 illustrates an example of a device interface selecting a plurality of security parameters, in accordance with embodiments of the present disclosure.

FIG. 5 illustrates another example of a device interface selecting a plurality of security parameters, in accordance with embodiments of the present disclosure.

It will be noted that throughout the appended drawings, like features are identified by like reference numerals.

### DETAILED DESCRIPTION

An object of embodiments of the present disclosure is to provide methods and systems of/for managing parking access entering or exiting from a multi-residential building, using a building operating system (BOS). The building operating system (BOS) used herein can act both as a facilitator, and as an operating system in the computing sense, which can coordinate many “programs” or “subroutines” that are “running” in a residence such as a building. For example, a program running in a building may be managing the registration and unregistration of the objects (e.g., vehicles or guests) approaching the building, and another program may be configured to generate a plurality of security parameters and match the security parameters captured in real time with any previously pre-determined security parameters stored in a database, server, cloud based server, etc. In accordance with embodiments of the present disclosure, a building operating system (BOS) may be integrated with entities and devices to facilitate the embodiments described herein.

As used herein, a “building” may be any location that requires controlled entry, controlled exit, or both controlled entry and exit, and may include any multi-residential or commercial building or property. Buildings may include an apartment building, an office building, a controlled access facility, a parking arcade or lot, a ferry, etc. Access to a building includes both manned or unmanned vehicles (including drones), pedestrians, etc.

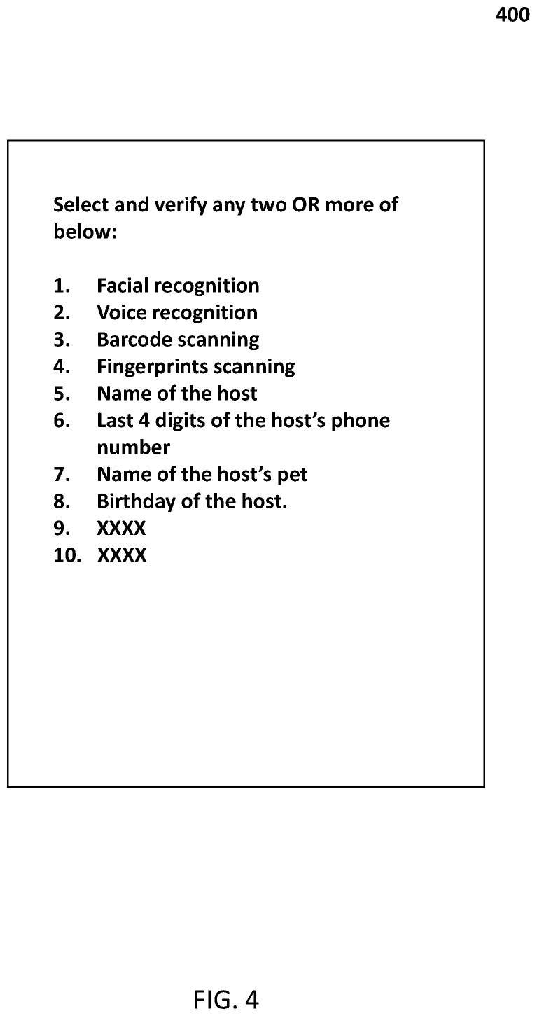

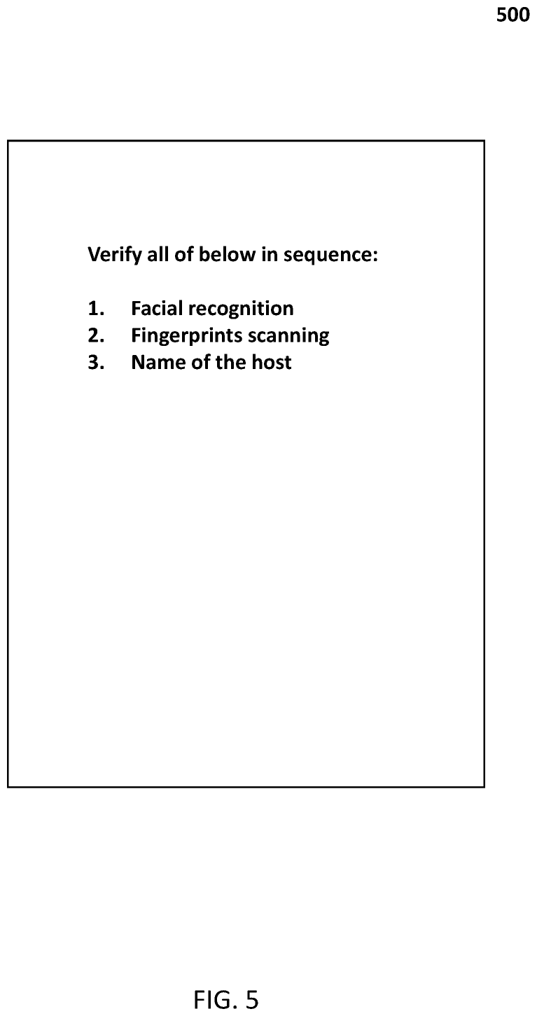

As used herein, a “user” may be a user associated with an object, such as a driver or passenger of a vehicle, etc. The “user” may also be the object itself, such as a delivery person, or a person attempting to enter or exit the building (e.g., a guest of a tenant in the building, a student attending to classes in the building). The user associated with an object may use a device interface to interact with the BOS. The device interface (e.g., indicated as 400 in FIG. 4 or as 500 in FIG. 5) may be a touchscreen or keyboard/keypad of a mobile device (e.g., a smartphone, tablet, computer), an interface mounted in (or on) the vehicle's dashboard, or a touchscreen or keyboard/keypad of a non-mobile device (such as an entry console with keypad or a touch screen device installed at the entrance of the building or anywhere in or near the building, etc.), or any other suitable device serving the same functions.

As used herein, an “authorization user” may be a tenant or a staff member, or both, or any other appropriate authorized person. A “user device” 101 may take the form of a mobile device such as a smartphone. A user device 101 may also take the form of a non-mobile device (such as an entry console with keypad or a touch screen device installed at the entrance of the building or anywhere in or near the building, etc.), or any other suitable device serving the same functions.

In relation to the present disclosure, a skilled person in the art should understand the term “real time” means a time frame that an ordinary person would sense as immediate or current. From the point of view of an object (i.e., a user associated with the object, such as a driver or a passenger of the vehicle) attempting to enter or exit a location, “real time” may be interpreted as being a sufficiently short time so as to not inconvenience the user, or a sufficiently short time so that the user does not feel that they are waiting. The latency may be less than a defined value, usually measured in seconds. In other words, “real time” should be short enough for a user to think the system is being responsive.

Furthermore, a skilled person in the art should understand that the embodiments relating to an object approaching a building may also apply to an object leaving a building, approaching or leaving a door or a detection facility that can detect movement of the object, etc.

Embodiments described herein provide methods of managing parking access into or exiting from a multi-residential building. Although example embodiments are described in reference to a residential building, a person skilled in the art may apply the methods and systems as described by example embodiments herein for a commercial building or a mixed-use building.

In relation to the present disclosure, a multi-residential building may be in the form of a multi-storey structure such as apartments or condominiums, a single-storey structure, a split-level structure, a multiplex structure such as duplex and triplex, or the like. In embodiments, a building may be a combination of any or all of the aforementioned structures. For example, a person skilled in the art should understand that a multi-residential building may be a gated community with security protocols, a closed perimeter of walls and/or fences, or the like.

Furthermore, the term “object” in the present disclosure may refer to a vehicle (e.g., a car, truck, bicycle, motorbike, scooter, ATV, or cart, and the like) or a person (e.g., a tenant or a guest, etc.) hereinafter. The term “tenant” may also refer to a resident currently living in the building or an owner of a unit who does not currently live in the building).

In accordance with an aspect of the present disclosure, there is provided a method of managing parking access into or exiting from a multi-residential building. The method includes: receiving a request of entry or exit in a building operation system (BOS) from an object via an interface; upon receiving the request of entry or exit, sending a validation request relating to a plurality of security parameters, from the BOS to the object, the plurality of security parameters being selected from a list of security parameters pre-determined and stored in a server, the number of the plurality of security parameters selected being less than or equal to the number of security parameters in the list of security parameters; receiving a response to the validation request in the BOS, the response being generated by the object in real time; and upon determination of a valid response to the validation request by the BOS, sending a response to the request of entry or exit to the object, wherein the response is a denial or an approval.

For example, the plurality of security parameters can be randomly selected from the list of security parameters in real time by the BOS. In another example, the plurality of security parameters can be pre-selected by a user from the list of security parameters.

In accordance with the embodiments, when the response from the BOS is an approval, an access control system performs one or more post-validation actions, when the response from the BOS is a denial, the access control system performs one or more notification actions.

Furthermore, the one or more post-validation actions comprise automating one or more controls in a building, such as automatically opening or closing a garage or gates, turning on or off the oven, lights, heating, or music, or automating elevator going up or down to a designated place, etc. The post-validation actions also include assigning parking space, and processing payments or fees. There may also be a service fee charged to the tenant depending on the level of post-validation actions that he or she chooses.

Notably, the request of entry or exit can be automatically generated when the object approaches a garage, a gate. a door, an entrance/exit, or a detecting facility of the building. It can also be a request manually launched by the object (e.g., a person or a driver of the vehicle pressing a button on the phone, the transponder, or touch screen of the entry console, etc.). Alternatively, it can be an automatically generated request upon detected movement of the object (e.g., when the vehicle starts to move).

In accordance with the embodiments, the BOS is configured to determine if a response/input from the object is a valid response to a request of entry or exit. A valid response can be a fully successful validation, a partially successful validation or a failed validation.

In an embodiment, if the vehicle or the person receives a partially successful validation or a failed validation (e.g., BOS generating a response to the request of entry or exit being a denial based on its analysis and determination), the method may further include sending an additional validation request relating to another plurality of security parameters, by the BOS to the object.

In another embodiment, if the object (e.g., the vehicle or the person) receives a partially successful validation or a failed validation (e.g., receiving the response to the request of entry being a denial from the BOS), the method may further send an alert notification to the object (i.e., the user associated with the object, such as driver or passenger of the vehicle, or a guest of a tenant attempting to enter or exit the building) and/or an authorization user (e.g., the tenant or the staff member, or both, or any other appropriate authorized person). The method may further allow the authorization user to override the response to the request of entry or exit. The notification may include the attempted security questions and answers entered, the facial and audio records of the person attempting to enter or exit the building, etc. In this manner, the authorization user can determine whether it is an innocent mistake or accident or technical glitches, or an illegal or unauthorized attempt (e.g., someone stealing a tenant's or a guest's vehicle or phone or transponder, etc., and trying to enter or exit the building). Accordingly, such records of failed validations and partial validations may be used for risk analysis with the parking access and security management in the building. For example, the percentage of attempted illegal or unauthorized entry or exit is higher than a threshold level, the tenant or the building management team may consider increasing the layers of validation process or increasing the complexity level of the security parameters.

In accordance with the embodiments, a method for registering an object (e.g., a vehicle, or a person) in a building (e.g., a multi-residential building) includes receiving a request to register an object (e.g., a vehicle, or a person such as a tenant or a guest of a tenant, or a person associated with a vehicle) by a building operating system (BOS) from a source (e.g., a user device); upon determination of a valid request by the BOS, sending the request to register the object by the BOS towards a server; completing the request to register the object including adding the information of the object in the server; receiving an acknowledgement that the object has been registered by the BOS from the server; and sending an acknowledgement that the object has been registered by the BOS toward the source. Registering an object may also be referred to as “whitelisting” an object. In other words, the list or group of registered or whitelisted objects is allowed into the building when everything else is denied by default. In embodiments, the server may include a network video recorder, an entity capable of computing, storage and processing, facial or audio recognition, etc., or a combination of multiple such entities, and the like. In embodiments, the server (which can be a networked server) is configured to store and process the request or information received/transmitted.

Similarly, in embodiments, a method for unregistering an object (e.g., a vehicle, a person) in a multi-residential building includes: receiving, by a building operating system (BOS) from a source, a request to unregister an object which is previously registered; sending, by the BOS towards a server, the request to unregister the registered object; completing the request to unregister the registered object including removing the information of the registered object in the server; receiving, by the BOS from the server, an acknowledgement that the registered object has been unregistered; and sending, by the BOS toward the source, an acknowledgement that the previously registered object has been unregistered. For example, once an object (e.g., a guest vehicle, or an old vehicle of the tenant, or a tenant who no longer lives in the building) information has been removed, the object can no longer enter or exit the building.

Similarly, in embodiments, there is provided a method for updating an object which is previously registered in the building. The method includes: receiving, by a building operating system (BOS) from a source, a request to update a registered object, the request comprising updating information of the registered object; upon determination of a valid request by the BOS, sending, by the BOS towards a server, the request to update the registered object; completing the request to update the registered object including update the information of the registered object in the server; receiving, by the BOS from the server, an acknowledgement that the registered object has been updated; and sending, by the BOS toward the source, an acknowledgement that the registered object has been updated.

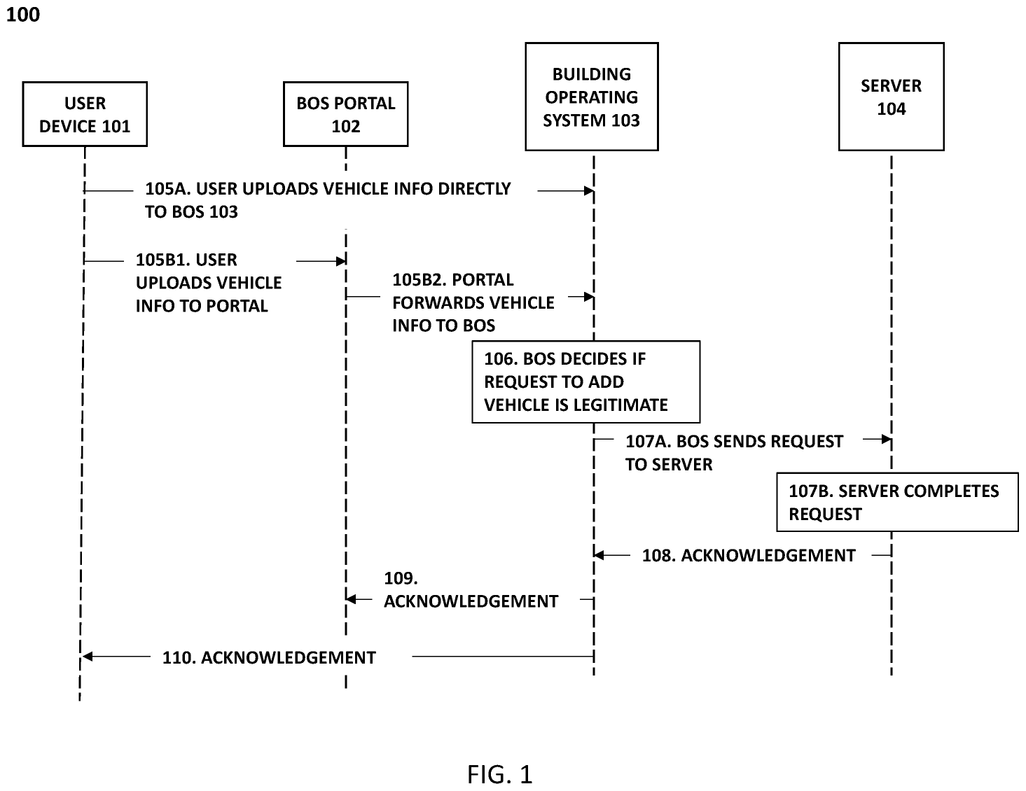

In some embodiments, the term “source” can refer to a mobile application (e.g., a downloadable software application on a smartphone, a tablet or a computer, etc.), a user device (e.g., a smartphone, a tablet or a computer) or a BOS portal (e.g., a website portal). There may be multiple sources involved in an embodiment. There can be a direct communication between one source to the BOS, for example, a request is sent directly from a mobile application to the BOS. In another example, a request can be submitted to a user device to a BOS portal and the BOS portal forwards the request with the information to the BOS (as illustrated in FIG. 1).

For example, an authorization user (e.g., a tenant in the building) can login the mobile application installed on his/her smartphone and submit a request to register his/her own vehicle or a guest's vehicle on the mobile application, accordingly a request to register the vehicle is received by the BOS. In another example, an authorization user (e.g., management staff of the building, etc.) can submit one or more requests to register the vehicle(s) of residents or tenants moving into the building, or unregister the vehicle(s) of residents or tenants moving out of the building. Furthermore, the authorization user can submit such a request by other means. For example, a request can be submitted via a user device directly (i.e., without going through a downloadable mobile application), by sending a text message to a designated number or sending an email to a designated email address thus triggering an automatic process or engaging an AI chat bot. In some embodiments, an automatic process can be switched to a manual process, an AI chat bot can be switched to a live agent conversation, etc. Furthermore, the authorization user can submit such a request via a BOS portal, for example, by logging into a BOS website portal.

In some embodiments (e.g., a vehicle approaching the building), the request typically contains information about one or more security parameters relating to the vehicle. A security parameter may correspond to one or more unique identifiers of the vehicle. For example, a security parameter can be a vehicle's colour, or it can be a vehicle's colour, make or model combined. Generally, the more unique identifiers combined in a security parameter, the increased complexity of the security parameter.

In embodiments, a unique identifier of a vehicle can be the vehicle's license plate number, the image of the vehicle's license plate, the colour of the vehicle, the make of the vehicle, the model of the vehicle, the driving patterns of the vehicle (with respect to one or more drivers using that vehicle), IP address of the vehicle, GPS location of the vehicle, and the like.

Driving patterns of the vehicle may be captured by a mix of sensors such as video cameras, radar, lidar, microphones, transponders, etc. and may evaluate driving characteristics such as acceleration, breaking position and speed, turning radius, etc. that may vary from driver to driver. In the case of a driveway or set path leading up to a point of authorization such as a kiosk, gate, door, etc. the BOS and/or server may store known characteristics of how an object approaches along the path.

The security parameters can also include an electronic device carried with the vehicle (e.g., a digital gadget, such as a transponder, installed in the vehicle or simply placed within or near the vehicle) and the electronic device may be sending information to other entities (e.g., the BOS), receiving information from other entities (e.g., the BOS), or processing information relating to the vehicle or relating to the driver or the owner of the vehicle.

In embodiments (e.g., a person approaching the building), the request typically contains information about security parameters relating to the person. A security parameter may correspond to one or more unique identifiers of the person. For example, a security parameter can be a person's birthday, or it can be a person's birthday, last four digits of the person's phone number combined. Generally, the more unique identifiers combined in a security parameter, the increased complexity of the security parameter. Notably, a person approaching the building can refer to a person walking towards the building, or a person driving a vehicle (or using any other transportation mode) approaching the building. A unique identifier of a person can be a facial recognition of the person; a voice recognition of the person; one or more security questions; a biometric record of the person including digital fingerprints; a digital form of behavioral biometrics of the person; and an electronic device carried with the person. For example, the security questions are typically related to the tenant in the building, which can be “when is his or her birthday?”, “who is his or her favourite teacher in grade 1”, “who is his or her favourite hockey player”, “how many pets does he or she have”, etc. Notably, the behavioural biometrics of a person (such as driving patterns) can indicate a person's mental status or capacity (e.g., whether he or she is intoxicated, depressed, or has Alzheimer's Disease etc.).

In embodiments, the access control system can be configured to perform various functions, such as opening the door, turning on (light) switches, turning on/off music, controlling the elevator, etc. In embodiments, access control system can be configured to send notifications or alerts, including contacting emergency, building management team, a tenant of the building, etc. The access control system can be an external entity, connected to the BOS via a communication technology. The access control system can also be an internal entity interfacing and managed by the BOS.

In embodiments, the server can include a database storing the requests received and the information including the security parameters submitted together with the requests. The server can be an external entity of the BOS and such an external server can be connected with the BOS via a wireless communication technology or any other suitable communication technology. Furthermore, the server can be an internal entity within the BOS and such an internal server can be connected with any other internal entities of the BOS (e.g., access control system). In practice, the server can be “refreshed” or “formatted” based on a pre-defined criteria (e.g., reaching a given time interval, reaching maximum of a certain storage space, or any other triggering condition or event). For example, the server may completely wipe out or remove the stored information. In another example, the server may be configured to store certain information (e.g., more important information) in a permanent storage space and other information (e.g., less important information) in a temporary storage space.

In accordance with the embodiments, an authorization user may include a tenant/resident, a staff person in the building (e.g., an employee from the BOS management team), or any other appropriate authorized person. Notably, the authorization user typically does not include a guest of the tenant in the building, for security concerns. However, exceptions may apply for a tenant lacking capacity (e.g., being a minor, being mentally incapable, being under supervision of a guardian, etc.). In such cases, a legal guardian or a third party in that role would be permitted to act as a “tenant” even though he or she does not live in the building or does not own a unit or a portion of the building.

In embodiments, the interface that the object uses to communicate or interact with the BOS can be any suitable device configured to recognize a unique identifier of the object. For example, it can be a mobile or portable device (such as a smartphone, tablet or a computer, a transponder, a sensor, even a wireless router with input and output interface, etc.), or a public or unportable device (such as an entry console or a touch screen device installed at the entrance of the building or anywhere in or near the building, etc.), or any other suitable device serving the same functions. The interface can also be a mobile application (e.g., downloadable on a device such as a smartphone). In an embodiment, the interface can be programmed or installed in the object, (e.g., the vehicle touch screen control system), or affixed or placed close to the object (e.g., the vehicle).

In accordance with the embodiments, a list of security parameters is pre-determined and stored in a server. For example, a person (e.g., a staff member of the building management team, a tenant of the building, an authorized person, etc.) can set up a total of k types (k≥2) of security parameters (i.e., vehicle colour, driver's license number, vehicle's license plate number, fingerprint, personal security questions, etc.) to form a list of pre-determined security parameters which is stored in the server to be used for the security validation process. For example, a person may further set up a rule for validation process that an input relating to p security parameters (2≤p≤k) must be collected in real time from the object and the input from the object must be compared with the pre-determined security parameters stored in the server, etc.

In an embodiment, the plurality of security parameters (e.g., p security parameters) is randomly selected from a list of security parameters (e.g., k security parameters) pre-determined and stored in a server. In a mathematical expression, the possible combination (if the order of the security parameters does not matter in practice) is kCp=k!/[p!(k−p)!]. For example, if the rule of the validation process requires two security parameters (p=2) to be randomly selected from a list of five (k=5) security parameters, the possible is 5C2=5!/[2!(5−2)!].

In an embodiment, the number of p does not need to be fixed. In other words, an object may be required to enter input relating to two security parameters, and another object may be required to enter input relating to four security parameters.

For example, as an object (e.g., a vehicle) approaches a door or a garage or a detection facility of a building with a request of entry (or exit) sent to the BOS, a plurality of security parameters will be randomly selected in the BOS at the spot, in real time and the object (e.g., the vehicle or the person in the vehicle) is required to send input relating to the randomly selected security parameters back to the BOS. It is extremely unlikely for the object (e.g., the driver of the vehicle) to foresee which one (or ones) from the list of the pre-determined security parameters will be used. It is possible that the driver of the vehicle does not need any interactive actions (with the BOS, etc.) such as manually entering an input via an interface before the BOS successfully validating the vehicle, for example, if the randomly selected security parameters happen to be the vehicle colour and the vehicle model. However, it is also possible that the driver must enter an input via an interface (e.g., smartphone, entry console of the building with touch screen or keyboard buttons, camera, etc.) in order to be successfully validated, for example, if the randomly selected security parameters happen to be voice recognition and security question(s).

In some embodiments, the selected security parameters can be a code, associated with the object (e.g., the vehicle or the person in the vehicle). In other embodiments, the code can be associated with the tenant/resident. In some embodiments, the code is a barcode. In some embodiments, the barcode can be one of: a one-dimensional linear bar code; a two-dimensional bar code, an image, specialized augmented postal code; intelligent mail barcode; and electronic product code.

For example, a barcode can be an encoded image (representation of data), usually displayed with black and white lines, but also in other variations, in various patterns that contains information that is readable by a machine. Barcodes may take various forms including non-specific one-dimensional (1D) linear barcodes, two-dimensional (2D) matrix barcodes, specialized augmented postal codes such as Postal Alpha Numeric Encoding Technique (PLANET), Postal Numeric Encoding Technique (POSTNET), Intelligent Mail barcodes, and other electronic product codes (EPC-s).

In some embodiments, the code is either static or randomly generated. A randomly generated code is a newly generated code in real time thus it is a different code everytime, increasing the security level.

The code can be attached to the vehicle's license plate, or somewhere inside or outside the vehicle (e.g., windshield), or to the object (e.g., the vehicle or the person in the vehicle) in any appropriate means. For example, the static code can be printed on a sticker which is attached to the vehicle's windshield, or simply printed on a piece of paper, or displayed on a mobile device or a screen built into the vehicle (e.g., a touchscreen or display that's mounted in (or on) the vehicle's dashboard). The code can be encoded or encrypted for security purpose. In some embodiments, the code can be illuminated, projected or be processed in any appropriate way in order to be visible in the dark.

In practice, the code is visible to and can be scanned by a scanning device, as one of the pre-determined security parameters. In embodiments, the scanning device can be a mobile or portable device (such as a smartphone, tablet or a computer, etc.), or a public or unportable device (such as an entry console installed at the entrance of the building or anywhere in or near the building, etc.), or any other suitable device serving the same functions.

In some embodiments, infrared light, ultraviolet light or non-visible lighting can be used for scanning which increases the level of security. In practice, an unauthorized person may take a photo of a barcode sticker and use it to “bypass” the security requirement related to scanning the barcode. For example, infrared light-based barcodes and QR codes that are embedded permanently into the bodies of 3D printed objects (e.g., invisible tags) can be detected or scanned by a corresponding device with infrared cameras. In relation to the present disclosure, any appropriate scanning means or device can be used.

Furthermore, in practice, it is advised to select at least one interactive security parameter as the mandatory validation requirement. For example, an authorization user can select voice recognition as the mandatory requirement for validation at all times and request the BOS to randomly select additional security parameters from the remaining ones in the list of pre-determined security parameters. Accordingly, as an example, one guest in one vehicle may be further prompted to display a barcode to a scanner at the entrance of the building after passing the voice recognition requirement, meanwhile, another guest in another vehicle may be further prompted to answer certain security questions after passing the voice recognition requirement.

Notably, a list of pre-determined security parameters is set up by an authorization user (e.g., a staff member of the building management team, a tenant of the building, an authorized person, etc.) and stored in the BOS. In embodiments, a plurality of security parameters is specifically picked by a user from a list of pre-determined security parameters stored in a server. The user herein can refer to a user associated with an object (such as driver or passenger of a vehicle), or an authorization user (such as tenant, resident or management staff of the building, any authorized person, etc.).

In one scenario, if the authorization user sets ten security parameters which are accordingly stored in the system and the authorization user further sets mandatorily at least two security parameters to be verified for every entry or exit request, thus every time an object (i.e., a user associated with the object) is required to self-pick at least two security parameters from the list of ten and send an input relating to these two self-picked security parameters to the BOS.

In another scenario, if the authorization user sets ten security parameters to be stored in the system and then the authorization user picks three specific security questions from the list of ten stored in the BOS, thus every time an object (i.e., a user associated with the object) is required to send an input relating to these three specific security parameters to the BOS. In other words, the object (i.e., the user associated with the object) does not have the option to self-pick from the list of pre-set and stored security parameters).

In another example, if the authorization user sets ten security parameters to be stored in the system and the authorization user further sets the BOS to randomly pick any three from the list of ten stored security parameters, thus every time an object (i.e., a user associated with the object) is required to send an input relating to any three specific parameters randomly generated by the BOS in real time. In other words, the object (i.e., the user associated with the object) does not have the option to self-pick from the list of pre-set and stored security parameters.

In some embodiments, the BOS is configured to select the plurality of security parameters from the list, based on a specific rule or in a priority order. Furthermore, the specific rule may be applicable to one or more respective groups of persons (e.g., guests, tenants, etc). In some embodiments, the BOS is configured to form one or more respective groups of persons. For example, it can be respective or different groups relating to a tenant (such as a group of family, a group of friends, etc). It can also be based on respective or different groups of specific tenants, etc.

Furthermore, the selected security parameters (either randomly selected in the BOS, or specifically pre-selected by a user) can be overridden at any given time or upon a pre-defined criterion (or criteria). For example, a tenant of the building, who wishes to increase the security level, may choose to increase the plurality of security parameters from an existing number to a higher number (e.g., two security parameters by default to be increased to four security parameters). There may also be a service fee charged to the tenant depending on the level of security he or she chooses.

In other words, the step of validation (also referred to as a multiple-layered validation process) is essentially comparing the security parameters entered by the object (i.e., submitted or captured in real-time) against the security parameters stored in the server.

Accordingly, the security level of managing parking access into or exiting from a multi-residential building is significantly enhanced. For example, a person stealing a resident's car and unlocked a smartphone can obtain the resident's home address (e.g., the address of the building) but he or she will be prohibited from entering (or exiting) the building for failing to pass security requirements of the BOS.

In practice, a validation can be a fully successful validation (e.g., 100% match), a partially successful validation (e.g., two out of the five randomly selected security parameters are matched correctly), a failed validation (e.g., none of the security parameters are matched correctly). Furthermore, it is possible to successfully validate a vehicle even if part of the vehicle license plate is covered by dust or debris. It is also possible to successfully validate a person even if part of the person's face is covered (e.g., by a mask or a scarf).

Some embodiments of the present disclosure will now be described with reference to specific examples. It will be understood that the following examples are intended to describe embodiments of the disclosure and are not intended to limit the disclosure in any way.

FIG. 1 is a sequence diagram of an example method 100 for registering (or unregistering) an object (e.g., a vehicle) to a building. The method 100 involves at steps 105A, or 105B1 and 105B2, receiving, by a building operating system (BOS) 103 from a source (for example, a user device 101 or a BOS portal 102), a request to register (or unregister) an object (e.g., a vehicle). At step 106, the BOS 103 determines if the request of entry (or exit) is a valid request. At step 107A, the BOS 103 sends towards a server 104, a request to register (or unregister) the object (e.g., the vehicle). At step 107B, the server 104 stores the information submitted by the object to complete the request to register the object (or remove the previously stored information to complete the request to register the object). At step 108, the BOS 103 receives from the server 104, an acknowledgement that the object (e.g., the vehicle) has been registered (or unregistered). Finally, at steps 109 or 110, the BOS 103 sends toward the source 101 or 102, an acknowledgement that the object (e.g., the vehicle) has been registered (or unregistered).

As mentioned previously, the source may be a user device 101 (shown in FIG. 1) or a BOS portal 102 (shown in FIG. 1) or a mobile application (not shown in FIG. 1). A user device 101 may take the form of a mobile device such as a smartphone. A user device 101 may also take the form of a non-mobile device (such as an entry console with keypad or a touch screen device installed at the entrance of the building or anywhere in or near the building, etc.), or any other suitable device serving the same functions. A BOS portal 102 may be a website or another software application.

The request of steps 105A, or 105B1 and 105B2 may include one or more security parameters of the object captured in real-time, for example, a picture of a license plate of a vehicle, a picture of a vehicle, or an internet protocol (IP) address of a vehicle, as may be the case for autonomous vehicles, or a face image recognized for a driver or a passenger within a vehicle, or a voice recognition of a person riding a scooter or a bicycle, a digital fingerprint(s) of a person pressing his or her finger(s) on a touchscreen or a biometric scanner or a biometric scanning application, or a security question answered by a person, a digital form of behavioral biometrics relating to a vehicle or a driver such as how the vehicle or the driver turns around the corner or approaches the building (i.e., driving patterns), etc. It will be appreciated by the person of skill in the art that these are non-limiting examples, and that the other information that can reasonably identify on object (e.g., a vehicle) may also be used, such as a unique wireless signal associated with the vehicle.

It is also mentioned previously that a person of skill in the art will also appreciate server 104 may be a component within the BOS 103, such that the server 104 is fully controlled by the BOS 103. In embodiments, the server 104 may include a network video recorder, an entity capable of computing, storage and processing, facial or audio recognition, etc., or a combination of multiple such entities, and the like. In embodiments, the server 104 (which can be a networked server) is configured to store and process the request or information received/transmitted.

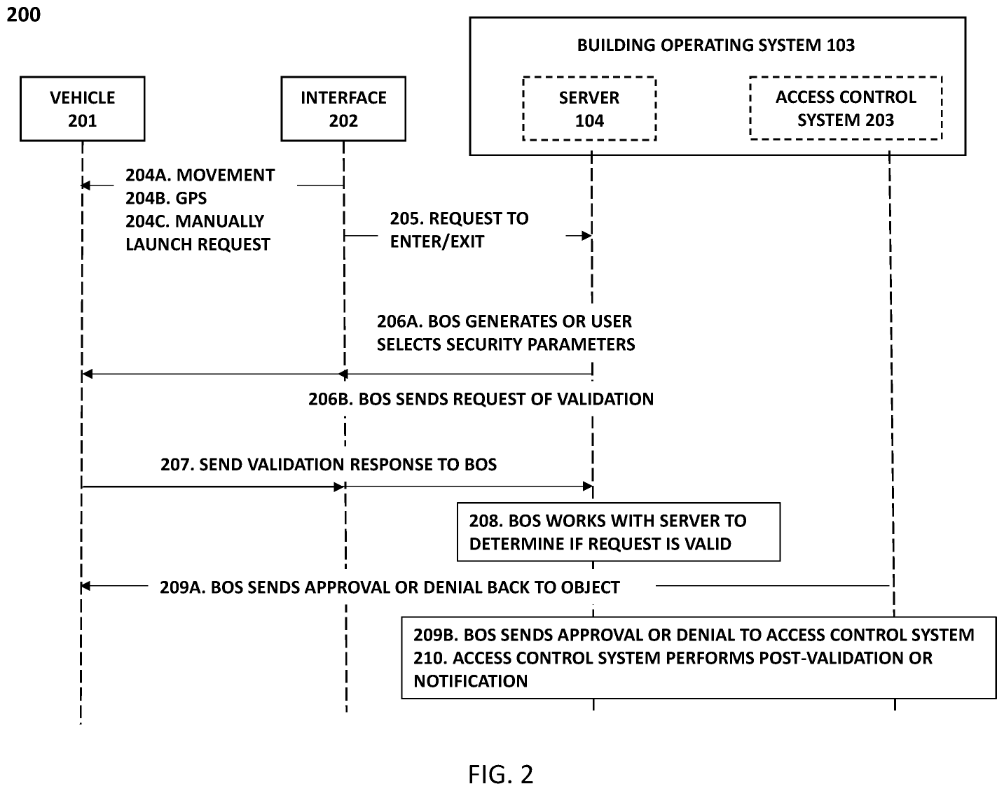

FIG. 2 is sequence diagram of an example method 200 for managing parking access or exiting from a multi-residential building. The method 200 includes, at step 205, sending, by an object via an interface 202 towards a building operating system (BOS) 103, a request relating to an object (e.g., a vehicle) 201. The request of entry (or exit) can be automatically triggered as an interface 202 detects a movement of the object (e.g., the vehicle) via step 204A as shown in FIG. 2 or as an interface 202 detects that the object is approaching a building (using GPS locations) via step 204B as shown in FIG. 2, or the request can be manually launched by the object (e.g., a person walking, riding a scooter, or driving an vehicle) via step 204B as shown in FIG. 2. At step 206A, the BOS 103 upon receiving the request of entry (or exit) either randomly selects a plurality of security parameters in real time from a list of security parameters stored in the server 104 or generate a plurality of security parameters pre-selected by a user (e.g., a user associated with the object such as driver or passenger in the vehicle, or an authorization user) from a list of security parameters stored in the server 104. At step 206B, the BOS 103 sends a validation request (which requires input relating to the plurality of security parameters generated or selected at step 206A) to the object (e.g., vehicle) 201 via the interface 202. At step 207, the object (e.g., the vehicle) 201 sends a validation response back to the BOS 103. At step 208, the BOS 103 determines if the validation response is valid (e.g., a fully successful validation, a partially successful validation, or a failed validation) by comparing the received input with the information stored in the server 104. At step 209A, the BOS 103 sends towards the object (e.g., the vehicle) 201, a response (e.g., an approval or a denial) relating to the request of entry (or exit) back to the object (e.g., the vehicle) 201. At step 209B, the BOS 103 sends towards the access control system 203, a response (e.g., an approval or a denial) relating to the request of entry (or exit). At step 210, the access control system 203 performs one or more post-validation actions upon receiving a response being an approval or the access control system 203 performs one or more notification actions upon receiving a response being a denial.

In some embodiments disclosed herein, the entrance of the building (e.g., garage) may be automatically opened for the vehicle's access after determination or validation at step 208 and/or sending a response at step 209A or 209B and/or post-validation actions at step 210. In some embodiments disclosed herein, the request at step 205 may be automatic when the vehicle 201 is in proximity to the building.

In the method 200, the BOS 103 may include a server 104 as a component of the BOS 103. Similarly, the BOS 103 may include an access control system 203.

In the method 200, at step 208 and step 209, a fully successfully validation (100% match) will trigger BOS to send a response of approval to the object 201 and the access control system 203, and a failed validation will trigger BOS to send a response of denial to the object 201 and the access control system 203. For a partially successful validation, BOS may send either an approval or a denial depending on the pre-defined policy or criteria within the BOS.

In one embodiment of the present disclosure, an object (e.g., a vehicle) may be identified based on other devices carried along with the object or present within the object (e.g., the vehicle). Transponders, embedded chips (e.g., 5G chips) or personal electronic devices (such as smartphones) may be used to identify an object (e.g., a vehicle) that is approaching a particular destination. An authorization user (e.g., a tenant or an owner of a unit in a building, or a personnel of a building management team, any other appropriate authorized person, etc.) may be able to register an object (e.g., a vehicle) with a software application on their smartphones, tablet computers, or the like, in order for an object (e.g., a tenant's vehicle, or a guest vehicle, etc.) to be identified. Registered objects (e.g., vehicles) may still need to be visually or audially confirmed in order to gain entry, as a personal electronic device may be easily transferred from one vehicle to another. Geolocation or other global positioning methods may be integrated to determine where a vehicle may be located at a given time.

A key advantage provided by the above embodiment is that in situations where reading or detecting a license plate may not be possible (either partially or fully), a building operating system may be able to successfully detect a vehicle based on, for example, the make, size, shape and/or colour of the vehicle (e.g., a Charcoal Dodge RAM), the identification of the driver of the vehicle (e.g., facial recognition), or another unique aspect of the vehicle (e.g. a dent at a particular spot, or a sticker on a specific part of the windshield), all of which may be stored in a database, together with the presence of a registered device within the vehicle. Having a multi-factor authentication method may provide security advantages such that a stolen electronic device cannot alone grant secure access to a location. Situations in which license plates may not be able to be read, such as where dust or debris cover a license plate, where the design of the license plates themselves results in poor recognition by cameras, or even where certain jurisdictions allow for no license plate to be required at the front end of a vehicle. This embodiment may also be advantageous in certain climates, where snow or ice may cover license plates, thereby impeding the ability to recognize them.

In some embodiments disclosed herein, it may be advantageous to link the described technologies with temporary rental services such as Airbnb. Authorized guests may easily acquire access to the building in which they have rented space, by providing the building with the necessary vehicle identification information. Customer or guest experiences may thus be collected, stored in databases and analyzed for industry statistics.

Another advantage of the present disclosure is to implement a validation process that utilizes a plurality of security parameters. For example, it is extremely unlikely for the driver of the vehicle to foresee which one of the security parameters will be used as they are randomly generated at the real time.

Furthermore, additional validation process may be triggered by a failed validation or a partial validation, depending on the pre-determined level of security chosen by the tenant or the building management team. A failed validation or a partial validation may trigger an alert notification sent to the tenant or the building management team and such attempted records can be used for risk analysis for the building (e.g., how many percentage of failed validation or partial validation is due to accident or mistakes or technical glitches, how many percentage is due to illegal or unauthorized attempts). Accordingly, a multi-layered system or a multi-layered validation process can greatly increase the security level of the building.

Another advantage is a multi-layered system that allows the building operating system to establish entry of an object (e.g., a vehicle or a driver of a vehicle or a person) with risk assessment associated with the behavioural patterns of the drivers. Data pertaining to driving indicators, such as driving speed of drivers (or operators), may be linked with the present application to determine driving patterns or a “fingerprint” for a particular driver. This may be performed on a driver's accompanying software application (for example, on a smartphone). The “fingerprint” may contain other information such as how the drivers (or operators) operate vehicles, or information regarding autonomous vehicles as the case may be. This capability to recognize driving patterns may be used to collect data in a database for statistical purposes. In some embodiments disclosed herein, the multi-layered system may be customized to include some or all of the factors described above to meet various security and/or risk assessment requirements.

Additional equipment such as transponders or personal electronic devices may be used in conjunction with the driving pattern recognition to determine whether a driver is or, for example, taking shortcuts or other local routes. Integration of local knowledge may help provide detailed data concerning the driving patterns of individual drivers as well as communities. This aspect may be further integrated with third-party services such as Uber, Lyft or Waze, to collect such behavioural biometric of such drivers.

In connection with advantages, the building operating system may be configured to begin monitoring the arrival of registered vehicles in advance. For example, the building operating system may be able to recognize that a registered vehicle is approaching from a particular distance away, and may begin monitoring the vehicle. This may be done to determine that a vehicle is following known driving patterns of the driver(s) as it arrives. For example, if a vehicle typically returns to a building via a regular route, the building operating system may send an alert if the vehicle for whatever reason is using a novel route to arrive. Other examples may include how a particular corner is turned at a particular street junction, or the typical speed that a vehicle usually moves at. Patterns may thus be matched to vehicles and used in situations where a vehicle may have been stolen, or a phone may have been stolen from the vehicle or if a different (or possibly unauthorized) driver is operating the vehicle, in order to generate an alert in advance that the vehicle is behaving out of the ordinary.

Furthermore, “machine learning” or artificial intelligence (AI) may be utilized to aid in the process of recognizing vehicles, license plates, faces of drivers, driving patterns or behavioural biometrics of drivers, and the like. Embodiments disclosed herein are naturally and suitably fitted to allow for “machine learning” to provide increasingly accurate recognition capabilities.

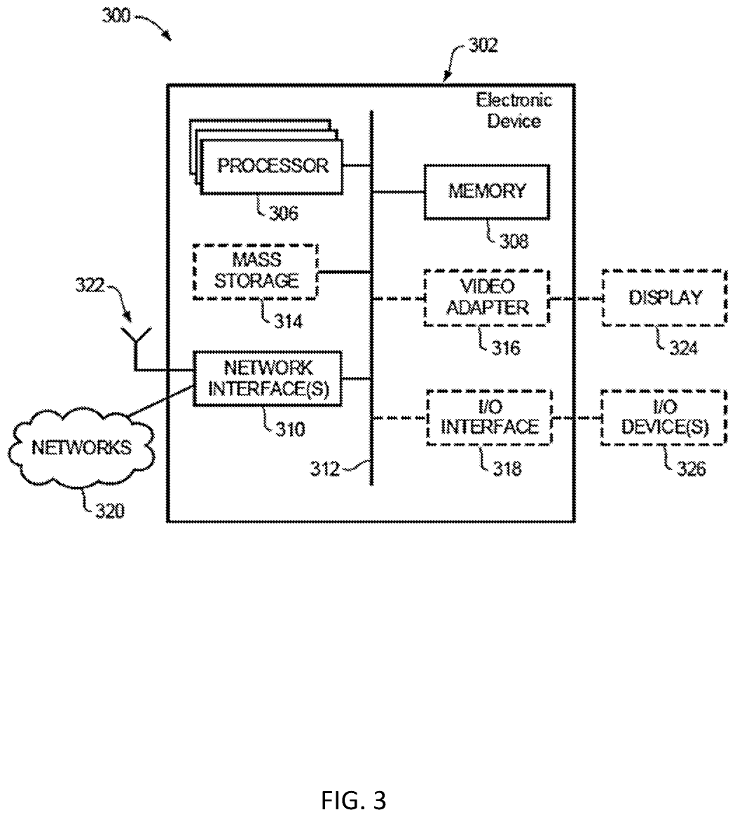

Referring now to FIG. 3, a schematic diagram is presented of an electronic device 300 that may perform any or all of operations of the above methods and features explicitly or implicitly described herein, according to different embodiments of the present disclosure. For example, a computer equipped with network function may be configured as electronic device 300. The device may be a mobile device or a device hosting the first function in the network.

As shown, the device includes a processor 310, such as a Central Processing Unit (CPU) or specialized processors such as a Graphics Processing Unit (GPU) or other such processor unit, memory 320, non-transitory mass storage 330, I/O interface 340, network interface 350, and a transceiver 360, all of which are communicatively coupled via bi-directional bus 370. According to certain embodiments, any or all of the depicted elements may be utilized, or only a subset of the elements. Further, the device 300 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

The memory 320 may include any type of non-transitory memory such as static random access memory (SRAM), dynamic random access memory (DRAM), synchronous DRAM (SDRAM), read-only memory (ROM), any combination of such, or the like. The mass storage element 330 may include any type of non-transitory storage device, such as a solid state drive, hard disk drive, a magnetic disk drive, an optical disk drive, USB drive, or any computer program product configured to store data and machine executable program code. According to certain embodiments, the memory 320 or mass storage 330 may have recorded thereon statements and instructions executable by the processor 310 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

As used herein, the term “about” should be read as including variation from the nominal value, for example, a +/−10% variation from the nominal value. It is to be understood that such a variation is always included in a given value provided herein, whether or not it is specifically referred to.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

FIG. 4 illustrates an example of a device interface selecting a plurality of security parameters, in accordance with embodiments of the present disclosure. In particular, the plurality of security parameters can be pre-selected by a user (i.e., a user associated with the object such as driver or passenger in the vehicle, or an authorization user such as tenant or management staff of the building, etc.) from the list of security parameters.

As mentioned in the present disclosure, an object or a user associated with an object (e.g., the driver or passenger of the vehicle) may be able to pre-select the security parameters from a list of security parameters pre-determined and stored in the BOS. For example, as illustrated in FIG. 4, a guest or user will be prompted to select and answer any two or more items from the list via a device interface 400. For example, if the guest or user is a close friend or family member of the tenant or resident of the building, that he or she may already have his or her facial recognition or voice recognition set up in the system so the guest can conveniently choose facial and voice recognition every time. However, if the guest or user is visiting for the first time and has not set up or stored any biometric information (including facial or voice recognition), he or she has the option to choose other security parameters from the shown list.

FIG. 5 illustrate another example of a device interface selecting a plurality of security parameters, in accordance with embodiments of the present disclosure. In one example, the plurality of security parameters can be randomly selected from the list of security parameters in real time by the BOS. For example, referring to FIG. 5, the BOS randomly selects a pre-defined number of security parameters (e.g., three selected security parameters) and the guest or user must answer or respond to these randomly selected security parameters (either in sequence if required, or not required in sequence) displayed via a device interface 500. Notably, the pre-defined number is set by an authorization user (such as tenant or management staff of the building, etc.), and can be updated or changed by an authorization user.

In another example (referring to FIG. 5), the (fixed) plurality of security parameters can be specifically selected from the list of security parameters by an authorization user so that a guest is prompted to verify the (fixed) specific security parameters displayed on a device interface 500.

In some embodiments, failing one time may lead to another attempt (e.g., second attempt, third attempt, etc.) The new attempt may have identical security parameters with the previous attempt, partially identical security parameters or completely different security parameters with the previous attempt. The security parameters of the new attempt can be randomly generated by the BOS from the list of security parameters or pre-selected by a user from the list of security parameters.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A method of managing parking access into or exiting from a multi-residential building, the method comprising:
receiving a request of entry or exit in a building operation system (BOS) from an object via an interface;
upon receiving the request of entry or exit, sending a validation request relating to a plurality of security parameters, from the BOS to the object, the plurality of security parameters being selected from a list of security parameters pre-determined and stored in a server, the number of the plurality of security parameters selected being less than or equal to the number of security parameters in the list of security parameters;
receiving a response to the validation request in the BOS, the response being generated by the object in real time; and
upon determination of a valid response to the validation request by the BOS, sending a response to the request of entry or exit to the object, wherein the response is a denial or an approval.

2. The method of claim 1, wherein the plurality of security parameters is randomly selected from the list of security parameters in real time by the BOS.

3. The method of claim 1, wherein the plurality of security parameters is pre-selected by a user associated with the object from the list of security parameters.

4. The method of claim 1, wherein when the response from the BOS is an approval, the method further comprising:
an access control system performing one or more post-validation actions including:
automatically opening or closing a garage or a gate,
turning on or off an oven, a light, heating, or music,
automating an elevator going up or down to a designated place,
assigning a parking space, or
processing a payment or a fee.

5. The method of claim 1, wherein when the response from the BOS is a denial, the method further comprising:
an access control system performing one or more notification actions including:
sending an additional validation request relating to another selected plurality of security parameters, by the BOS to the object; or
allowing an authorization user to override the response to the request of entry or exit.

6. The method of claim 1, wherein the request of entry or exit includes an automatically generated request upon the object approaching the multi-residential building.

7. The method of claim 1, wherein the request of entry or exit includes a request being manually launched by the object.

8. The method of claim 1, wherein the request of entry or exit includes an automatically generated request upon movement of the object.

9. The method of claim 1, wherein the object is a vehicle and the security parameters include one or more identifiers of the vehicle, selected from:
a code associated with the vehicle;
a license of the vehicle;
a colour of the vehicle;
a make of the vehicle;
a model of the vehicle;
a driving pattern of the vehicle;
an IP address of the vehicle;
a GPS location of the vehicle; and
an electronic device carried with the vehicle.

10. The method of claim 1 wherein the object is a person and the security parameters include one or more identifiers of the person, selected from:
a code associated with the person;
a facial recognition of the person;
a voice recognition of the person;
one or more security questions to be answered by the person;
a biometric record of the person including digital fingerprint(s);
a digital form of behavioral biometrics of the person; and
an electronic device carried with the person.

11. The method of claim 1, further comprising registering the object in the multi-residential building, which comprises:
receiving, by the BOS from a source, a request to register the object, the request comprising adding information of the object;
upon determination of a valid request by the BOS, sending, by the BOS towards the server, the request to register the object;
completing the request to register the object including adding the information of the object in the server;
receiving, by the BOS from the server, an acknowledgement that the object has been registered; and
sending, by the BOS toward the source, an acknowledgement that the object has been registered;
wherein the information comprises one or more security parameters.

12. The method of claim 11, further comprising unregistering the object which is previously registered in the multi-residential building, which comprises:
receiving, by the BOS from a source, a request to unregister the object, the request comprising removing information of the object;
upon determination of a valid request by the BOS, sending, by the BOS towards the server, the request to unregister the object;
completing the request to unregister the object including removing the information of the object in the server;
receiving, by the BOS from the server, an acknowledgement that the object has been unregistered; and
sending, by the BOS toward the source, an acknowledgement that the object has been unregistered;
wherein the information comprises one or more security parameters.

13. The method of claim 11, further comprising updating the object which is previously registered in the multi-residential building, which comprises:
receiving, by the BOS from a source, a request to update the object, the request comprising updating information of the object;
upon determination of a valid request by the BOS, sending, by the BOS towards the server, the request to update the object;
completing the request to update the object including update the information of the object in the server;
receiving, by the BOS from the server, an acknowledgement that the object has been updated; and
sending, by the BOS toward the source, an acknowledgement that the object has been updated;
wherein the information comprises one or more security parameters.

14. The method of claim 1, wherein the interface includes one or more of:
a device configured to recognize an identifier of the object;
a mobile application;
a transponder; and
a wireless router.

15. The method of claim 1, wherein the source includes one of a mobile application, a user device or a BOS portal.

16. The method of claim 1, wherein the BOS includes a server and an access control system.

17. The method of claim 9, wherein the code includes one of: a one-dimensional linear bar code; a two-dimensional bar code, an image, a specialized augmented postal code; an intelligent mail barcode; and an electronic product code.

18. The method of claim 10, wherein the code includes one of: a one-dimensional linear bar code; a two-dimensional bar code, an image, specialized augmented postal code; an intelligent mail barcode; and an electronic product code.

19. A tangible, non-transitory computer readable medium having instructions recorded thereon to be performed by at least one processor to carry out a method as defined in claim 1.

20. A system comprising:
at least one processor; and
a tangible, non-transitory computer readable medium having instructions recorded thereon to be performed by the at least one processor to carry out a method as defined in claim 1.
